(19) United States
(12) Patent Application Publication
(10) Pub. No.: US 2006/0131125 A1
(43) Pub. Date: Jun. 22, 2006

(54) Wet type friction plate

(75) Inventors: Yoshio Kinoshita, Fukuroi-shi (JP); Shiro Takeuchi, Fukuroi-shi (JP); Tatsuro Miyoshi, Fukuroi-shi (JP); Shigeki Umezawa, Fukuroi-shi (JP); Shun Kitahara, Fukuroi-shi (JP); Tamotsu Fujii, Fukuroi-shi (JP); Hiroyuki Kinpara, Fukuroi-shi (JP); Kenji Maruo, Fukuroi-shi (JP); Tomoyuki Miyazaki, Fukuroi-shi (JP); Xiaoming Gu, Fukuroi-shi (JP); Fumimasa Muramatsu, Fukuroi-shi (JP); Ritsuo Toya, Fukuroi-shi (JP); Shigeharu Nishimura, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K. K.

(21) Appl. No.: 11/254,709

(22) Filed: Oct. 21, 2005

(30) Foreign Application Priority Data
Oct. 22, 2004 (JP) 2004-308448

(51) Int. Cl. B05D 5/00

(52) U.S. Cl. 192/113.36; 192/70.12

(57) ABSTRACT

In a wet type friction plate having a groove through which lubricating oil passes, the groove is subjected to oil repelling treatment.

### BACKGROUND OF THE INVENTION

1. Field of the Invention

The present invention relates to a wet type friction plate, for example, used in a wet type multi-plate clutch for an automatic transmission of a motor vehicle and, more particularly, it relate to the improvement in a groove formed in the wet type friction plate.

2. Related Background Art

In wet type multi-plate clutches, in order to reduce drag during idle rotation, there have been proposed techniques in which radial grooves are formed in a friction plate to quickly discharge oil from between the friction plate and a separator plate.

For example, Japanese Patent Application Laid-open No. 4-136524 (1994) discloses a, friction plate having grooves in which a cross-sectional area of each groove formed in the friction plate is greater at its outer peripheral side than at its inner peripheral side so that lubricating oil can easily pass from the inner periphery to the outer periphery of the friction plate, for the purpose of reducing power loss.

However, in order to meet a requirement of light-weight and compactness imposed to recent automatic transmissions, it has been desired that a friction capacity per one friction plate be increased. To this end, increase in the number of grooves formed in the friction plate and a dimension of the groove have been limited severely.

### SUMMARY OF THE INVENTION

Therefore, an object of the present invention is to provide a wet type friction material which can enhance an oil discharging ability in order to realize reduction in drag during idle rotation, without changing the number of grooves and a dimension of the groove in the prior art.

To achieve the above object, the present invention provides a wet type friction plate provided at its friction surface with grooves through which lubricating oil flows, in which the grooves are subjected to oil repelling treatment.

Since the oil repelling treatment is applied to the grooves formed in the friction surface, even when the number of grooves is the same as the conventional cases, the drag can be further reduced.

### BRIEF DESCRIPTION OF THE DRAWINGS

FIG. 1 is an axial partial sectional view of a wet type multi-plate clutch to which a wet type friction plate according to the present invention is applied;

FIG. 2 is a front view of the friction plate used in the wet type multi-plate clutch of the present invention;

FIG. 3 is a partial side view of the friction plate, showing a groove looked at from a direction A in FIG. 2; and

FIG. 4 is a graph showing a relationship between number of rotation and drag torque.

### DESCRIPTION OF THE PREFERRED EMBODIMENTS

Now, the present invention will be fully described with reference to the accompanying drawings. Incidentally, it should be noted that an embodiment described hereinbelow is a merely example of the present invention and does not limit the scope of the invention. Further, the same or similar parts are designated by the same reference numerals in the drawings.

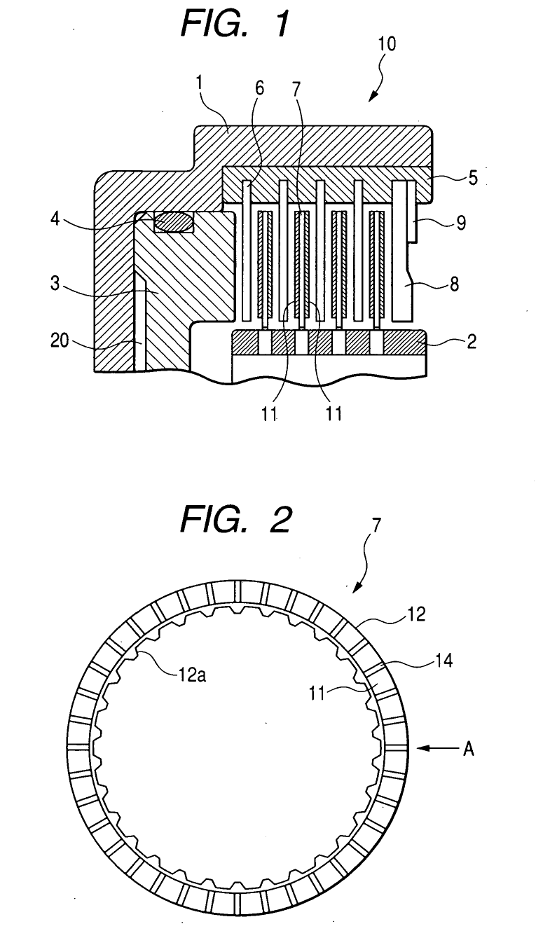

FIG. 1 is an axial partial sectional view of a wet type multi-plate clutch 10 to which a wet type friction plate according to the present invention is applied. The wet type multi-plate clutch 10 comprises a clutch housing 1, a piston 3 fitted in a closed end portion of the clutch housing 1 via an O-ring 4 in an oil-tight manner and capable of being shifted in an axial direction, a plurality of friction plates 7 fitted in splines of a hub 2, and a plurality of separator plates 6 arranged alternately with the friction plates and fitted in a spline portion 5 provided on an inner peripheral surface of the clutch housing 1.

A backing plate 8 secured by a stopper ring 9 is provided within an open end portion of the clutch housing 1. Friction materials 11 are secured, by an adhesive, to both axial surfaces of each friction plate 7.

In the wet type multi-plate clutch having the above-mentioned arrangement, engaging and disengaging operations are performed as follows. Incidentally, FIG. 1 shows a disengaging condition of the wet type multi-plate clutch 10. When oil is supplied to an oil chamber 20 defined between the closed end portion of the clutch housing 1 and the piston 3, the piston 3 is shifted to a right direction in FIG. 1 by oil pressure.

When the piston 3 is further shifted axially, the piston abuts against the separator plate 6 and then is further shifted while urging the separator plate. Ultimately, the piston urges all of the separator plates 6 an d all of the friction plates 7 against the backing plate 8 while pinching all plates between the piston and the backing plate. As a result, an engaging condition of the wet type multi-plate clutch 10 is achieved. When the oil is released from the oil chamber 20, the piston 3 is returned to an initial position by a return spring (not shown), thereby returning the wet type multi-plate clutch 10 to the disengaging condition.

FIG. 2 is a front view of the friction plate 7 of the present invention used in the wet type multi-plate clutch 10 shown in FIG. 1. The friction plate 7 is constituted by fixing an annular friction material 11 to a substantially annular core plate 12. Splines 12a are formed in an inner peripheral surface of the core plate 12, which splines are engaged by splines of the hub 2. A plurality of grooves 14 is formed in a friction surface of the friction plate 7 equidistantly in a circumferential direction.

The grooves 14 extending and piercing from an inner diameter side to an outer diameter side are obtained by deformation processing or press working of the annular friction material 11. However, the friction material may not be annular but may be formed as separate segments; in this case, the grooves 14 are formed as gaps between the segments and, in this case, the surface of the core plate 12 is exposed between the segments.

Each groove 14 is subjected to oil repelling treatment to reduce drag during rotation more effectively. In the illustrated embodiment, the following oil repelling treatment is performed.

(1) A coating material having an oil repelling property is coated on the surface of each groove 14;

(2) Each groove 14 is worked to have an oil repelling configuration; or

(3) A film having an oil repelling configuration is coated on the surface of each groove 14.

In the example (1), fluoro-compound or silicon compound is used as the coating material having the oil repelling property. As the fluoro-compound, for example, polytetrafluoroethylene, tetrafluoroethylene-hexafluoropropylene copolymer and the like can be used, and, as the silicon compound, for example, dimethylsilicon, silane compound can be used.

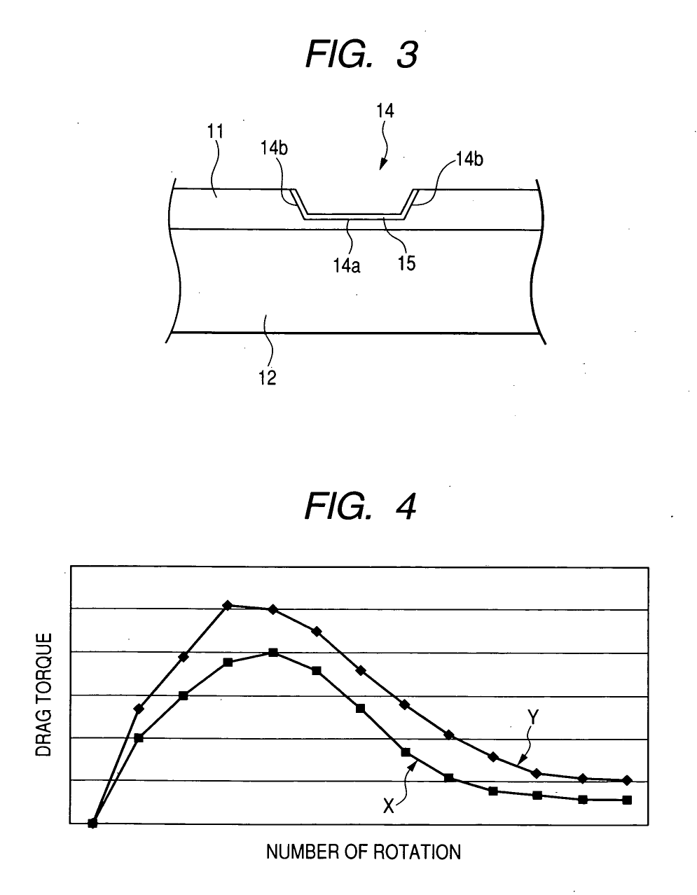

FIG. 3 is a partial side view of the friction plate, showing the groove 14 looked at from a direction shown by the arrow A in FIG. 2. The groove 14 is formed by deformation processing of the friction material 11 adhered to the core plate 12 and a bottom surface 14a and side surfaces 14b of the groove are coated by a coating material to form a coating material layer 15. Incidentally, the coating material layer 15 is shown exaggeratedly for easy explanation and is a very thin layer actually.

As the example (2) that each groove is worked to have the oil repelling configuration, fine or minute indentation is provided on the bottom surface and/or the side surface of the groove 14. For example, the indentation may have center face average roughness of about 1 to 100 μm. Further, when the grooves 14 are formed in the annular friction material 11, such indentation is formed on the friction material 11; whereas, when the segments of the friction material 11 are adhered to the core plate 12 so that the surface of the core plate defines the bottom of the groove 14, the indentation is formed on the surface of the core plate 12. The indentation can be formed simultaneously with the formation of the groove 14.

In the example (3) that the film having the oil repelling configuration is coated, similar to the coating treatment, the film is adhered to the groove 14. Although the film having the oil repelling configuration is preferable, any film having no oil repelling configuration may be used so long as the film itself has a predetermined oil repelling property. Further, an oil repelling configuration may be given to a film having an oil repelling property.

FIG. 4 is a graph showing a relationship between number of rotation and drag torque. A curve obtained by the friction plate of the present invention is shown by X and a curve obtained by the conventional friction plate is shown by Y. It can be seen that, regardless of the number of rotation, the drag torque of the friction plate of the,present invention is reduced more than the drag torque of the conventional friction plate.

It should be noted that the above-mentioned invention can be applied to not only the friction plate in which the friction materials 11 are adhered to both surfaces of the core plate 12 as shown in FIG. 1 but also the friction plate in which the friction material 11 is adhered to one surface of the core plate as shown in FIG. 3.

This application claims priority from Japanese Patent Application No. 2004-308448 filed on Oct. 22, 2004, which is hereby incorporated by reference herein.

What is claimed is:

1. A wet type friction plate having a groove through which lubricating oil passes, wherein said groove is subjected to oil repelling treatment.

2. A wet type friction plate according to claim 1, wherein the oil repelling treatment is achieved by coating a coating material having an oil repelling property on said groove.

3. A wet type friction plate according to claim 2, wherein said coating material includes fluoro-compound.

4. A wet type friction plate according to claim 2, wherein said coating material includes silicon compound.

5. A wet type friction plate according to claim 1, wherein said groove has an oil repelling configuration.

6. A wet type friction plate according to claim 5, wherein said oil repelling configuration includes indentation.

7. A wet type friction plate according to claim 6, wherein said oil repelling configuration is formed upon formation of said groove.

8. A wet type friction plate according to claim 6, wherein said oil repelling configuration is formed on a core plate constituting said wet type friction plate.

9. A wet type friction plate according to claim 1, wherein the oil repelling treatment is achieved by fixing a film having an oil repelling configuration to said groove.
